(19) United States
(12) Patent Application Publication
(10) Pub. No.: US 2016/0203103 A1
(43) Pub. Date: Jul. 14, 2016

(54) INTEGRATED FRAMEWORK OF MEMORY STORAGE MODULE AND SENSOR MODULE

(71) Applicant: Silicon Integrated Systems Corp., Hsinchu City (TW)

(72) Inventors: Ming Cheng Yu, Hsinchu City (TW); Min Han Lee, Hsinchu City (TW); Sin Kuo Cho, Hsinchu City (TW)

(73) Assignee: Silicon Integrated Systems Corp., Hsinchu City (TW)

(21) Appl. No.: 14/989,824

(22) Filed: Jan. 7, 2016

(30) Foreign Application Priority Data
Jan. 8, 2015 (TW) 104100568

(51) Int. Cl. G06F 15/78; G06F 9/38; G06F 12/02

(52) U.S. Cl. CPC G06F 15/786; G06F 12/0246; G06F 9/3836; G06F 2212/7201; G06F 2212/2022; G06F 2212/171

(57) ABSTRACT

An integrated framework of a memory storage module and a sensor module comprises a sensor controller, an embedded memory storage device controller, a microcontroller, and a non-volatile memory. By way of integrating the sensor controller and the embedded memory storage device controller sharing a same microcontroller and a same non-volatile memory, the complexity of packaging and the manufacturing cost are accordingly reduced.

### TECHNICAL FIELD OF THE INVENTION

The present invention relates to an integrated framework, and more particularly, to an integrated framework of a memory storage module and one or more entities or types of sensor modules.

### BACKGROUND OF THE INVENTION

Nowadays, electronic devices (especially, hand-held devices such as cell phones, smart phones, and tablets) generally adopt mass storage devices to store data. For example, non-volatile flash memory is a common mass storage device. There are many types of interfaces connecting the non-volatile flash memory to the electronic device and for example, the interface may include Multimedia Card (MMC), embedded memory storage device (eMMC) interface, and eMCP (eMMC with dynamic random access memory added). Other interfaces are Secure Digital Card (SD card) interface, Universal Flash Storage (UFS) interface, Open NAND Flash Interface (ONFI), and Toggle Flash Interface.

The storage media of the electronic devices (especially, hand-held devices) usually adopts the memory storage module complying with MMC standards. This type of memory storage device usually integrates an eMMC controller, a microcontroller, and a non-volatile memory. This is so-called embedded storage device with eMMC interface. These elements can be packaged into a unity by using Ball Grid Array (BGA) packaging.

FIG. 1 is a block diagram showing a storage deployment in a conventional electronic device 10. The electronic device 10 can be various electronic products, especially a hand-held electronic device such as a smart phone and a tablet. Taking the embedded memory storage device eMMC for example, as shown in FIG. 1, the conventional electronic device 10 comprises a primary processor 10, a memory storage module 120 (using an eMMC module for illustration), and a sensor module 130. The eMMC module 120 comprises an eMMC controller 122 and a first microcontroller 124 assigned to the eMMC controller 122. The eMMC module 120 also has a first non-volatile memory 126 and the eMMC controller 122 thus accesses the data stored in the first non-volatile memory 126 via the first microcontroller 124. The sensor module 130 comprises a sensor controller 132 and a second microcontroller 134 assigned to the sensor controller 132. The sensor module 130 also has a second non-volatile memory 136 and the sensor controller 132 thus access the data stored in the second non-volatile memory 136 via the second microcontroller 134. For example, the first non-volatile memory 126 is NAND flash type memory, and the second non-volatile memory 136 is NOR flash type memory or other types of non-volatile memory. The second non-volatile memory 136 may be integrated into the sensor controller 132 or packaged in the sensor module 130 by a manner of stacking.

Generally speaking, the eMMC module 120 has a static random access memory (not shown) such as SRAM deployed therein, which is usually located in the first microcontroller 124 and is provided for the first microcontroller 124. In addition, the sensor module 130 also has a SRAM, which is integrated in the second microcontroller 134 and is provided for the second microcontroller 134. Therefore, the data in the first (or the second) non-volatile memory 126 (or 136) may first be read to the static random access memory, and then the first (or the second) microcontroller 124 (or 134) accesses the static random access memory for increasing the read performance.

In the conventional electronic device 10 illustrated with the embedded memory storage device eMMC, the eMMC module 120 and the sensor module 130 (e.g., a touch sensor module) are provided by different manufactures, and the manufactures will not produce them all due to divergence of their technologies and division of supply chain. Therefore, in an aspect of packaging structure, the eMMC module 120 and the sensor module 130 will not be packaged in a same packaging structure. For the eMMC module 120 in the conventional skills, MCP (Multi Chip Package) is usually adopted to package the eMMC controller 122 and the first non-volatile memory 126. The first non-volatile memory 126 may be packaged in a manner of stacking. For the sensor module 130, the sensor controller 132 (e.g., a touch sensor controller), the second microcontroller 134, and the second non-volatile memory 136 are usually packaged in a package body or integrated in a same IC wafer, and the microcontroller 134 and other sensors such as an inertial sensor, a gyroscope sensor, an altimeter sensor, a temperature sensor, and a microphone sensor, are manufactured on different silicon wafers or packaged in different package bodies. Further, in the conventional skills, the elements of the eMMC module 120 are not in associated with the elements of the sensor module 130 due to the different functions provided by the eMMC module 120 and the sensor module 130. Besides, the eMMC module 120 and the sensor module 130 are connected to the primary processor 110 via different transmission interfaces, as shown in FIG. 1.

The conventional electronic device 10 has the following technical redundancy that it can be improved. First, the memory storage module such as the eMMC module 120 itself implements a microcontroller, a non-volatile memory, and a static random access memory (SRAM), and the sensor module 130 itself also implements a microcontroller, a non-volatile memory, and a static random access memory (SRAM). Each of microcontroller, non-volatile memory, and static random access memory (SRAM) implemented in the memory storage module 120 and the sensor module 130 has similar functions. It turns out the cost increasing by the duplication of similar silicon intellectual property. Second, in the conventional skills, the sensor module 130 and the memory storage module such as the eMMC module 120 are packaged in separated manufacture processes and package bodies that make high cost of packaging, and occupied two package areas on a printed circuit board (PCB).

### SUMMARY OF THE INVENTION

An objective of the present invention is to provide an integrated framework of a memory storage module and a sensor module, for reducing the use of silicon intellectual property and lowering the cost of packaging.

To achieve the above objective, the present invention provides an integrated framework of a memory storage module and a sensor module, comprising: an embedded memory storage device controller; a microcontroller coupled to the embedded memory storage device controller; a non-volatile memory coupled to the microcontroller, the embedded memory storage device controller reading a data from the non-volatile memory or writing the data to the non-volatile memory by use of the microcontroller; and a sensor controller for controlling a sensing element to generate or receive a sensing signal; wherein the sensor controller is coupled to the microcontroller, and the sensor controller reads the data from the non-volatile memory or writing the data to the non-volatile memory by use of the microcontroller.

In the present invention, the embedded memory storage device controller (such as the eMMC controller) and the sensor controller share the microcontroller and the non-volatile memory. Both of the embedded memory storage device controller and the sensor controller operate a same microcontroller to access the saved data or the hardware execution data (such as software program codes, firmware, operating parameters, and other data) stored in the non-volatile memory. The firmware codes and data relative to both of the embedded memory storage device controller and the sensor controller are stored in the non-volatile memory. Sensing signals generated by sensor elements may be further computed by use of the microcontroller. Compared to the conventional electronic devices, the microcontroller and the non-volatile memory of the present invention are shared by the embedded memory storage device controller and the sensor controller, and therefore it does not need to deploy a separated microcontroller and a separated non-volatile memory for each of the embedded memory storage device controller and the sensor controller as the conventional skills do. Therefore, compared to the conventional skills, the present invention reduces the use of silicon intellectual property, the cost of silicon wafer is accordingly reduced, and the cost of packaging is lowered as well.

### BRIEF DESCRIPTION OF THE DRAWINGS

FIG. 1 is a block diagram showing a memory deployment in a conventional electronic device.

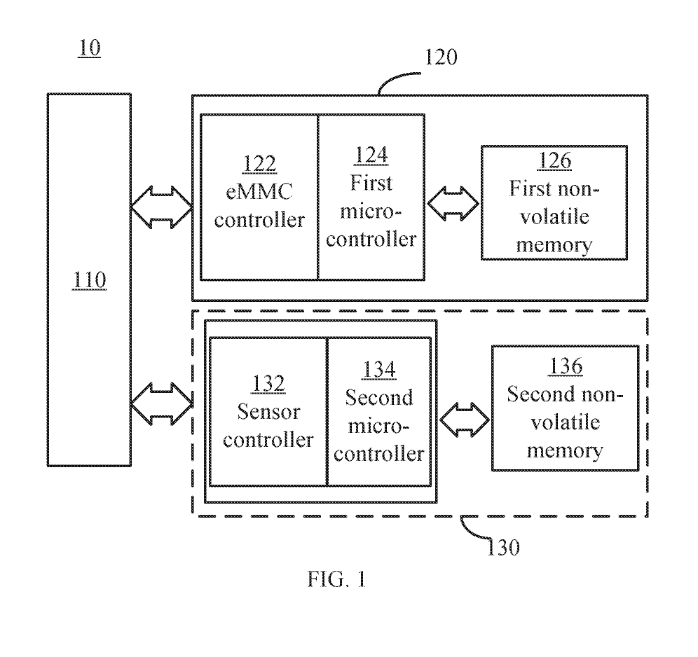

FIG. 2 is a block diagram showing a device in accordance with a first embodiment of the present invention.

FIG. 3 is a block diagram showing sensors and a sensor controller in accordance with the present invention.

FIG. 4 is a block diagram showing a device in accordance with a second embodiment of the present invention.

FIG. 5 is a block diagram showing a device in accordance with a third embodiment of the present invention.

FIG. 6 is a block diagram showing a device in accordance with a fourth embodiment of the present invention.

FIG. 7 is a block diagram showing a device in accordance with a fifth embodiment of the present invention.

FIG. 8 is a block diagram showing a device in accordance with a sixth embodiment of the present invention.

FIG. 9 is a block diagram showing a device in accordance with a seventh embodiment of the present invention.

### DETAILED DESCRIPTION OF THE INVENTION

To make above objectives, features, and advantages of the present invention more apparently, the present invention will be described in detail below with reference to preferable embodiments and the appending drawings. In the drawings, a same reference number may indicate similar or the same elements.

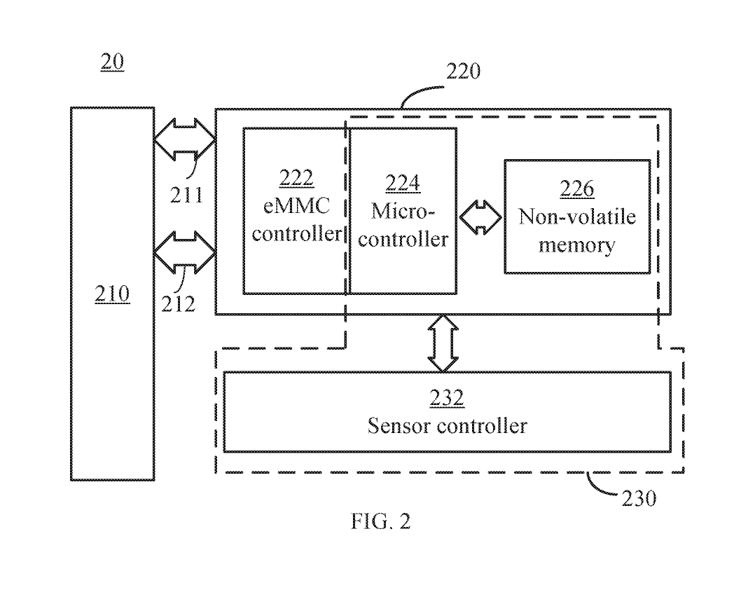

FIG. 2 is a block diagram showing a device 20 in accordance with a first embodiment of the present invention. The device 20 can be any kind of electronic products, especially hand held electronic devices such as cell phones, smart phones, and tablets. The device 20 comprises a primary processor 210, a memory storage module 220, and a sensor module 230.

The memory storage module 220 comprises an embedded memory storage device controller such as an eMMC (embedded Multimedia Card) controller 222 and a microcontroller 224 configured for the eMMC controller 222. The memory storage module 220 also has a non-volatile memory 226 and the eMMC controller 222 accesses the non-volatile memory 226 just by the microcontroller 224.

The embedded memory storage device can also be Multimedia Card (MMC), eMCP (eMMC with dynamic random access memory added), Secure Digital Card (SD card), Universal Flash Storage (UFS), Open NAND Flash Interface (ONFI) Flash, and Toggle Interface Flash, or any storage device complying with other standards. Noted that in the context, the embedded memory storage device controller is illustrated by the eMMC controller 222, but is not limited thereto.

The sensor module 230 has a sensor controller 232. As shown in FIG. 2, the sensor controller 232 uses the microcontroller 224 of the memory storage module 220 to access, through an transmission interface between the sensor controller 232 and the memory storage module 220, the non-volatile memory 226 of said module 220. That is to say, the eMMC controller 222 of the memory storage module 220 and the sensor controller 232 of the sensor module 230 share the microcontroller 224 and the non-volatile memory 226. The shared microcontroller 224 may also provide computation for the eMMC controller 222 and the sensor controller 232 in addition to accessing the data stored the non-volatile memory 226.

The primary processor 210 is a central processor unit (CPU) of a smart phone, for example. Preferably, the memory storage module 220 is carried out by an eMMC (embedded memory storage device) module. The sensor module 230 may include a touch sensor, but is not limited thereto. The non-volatile memory 226 may be implemented by a flash memory such as NAND flash and/or NOR flash. The flash memory has a storage array structure which includes a plurality of blocks, each of which consists of a number of pages.

Taking the eMMC controller 222 as the embedded memory storage device controller for example, as shown in the device 20 in FIG. 2, the primary processor 210 is connected to the eMMC controller 222 of the memory storage module 220 via a MMC bus 211, and instructions and data are transmitted there between. Also, the primary processor 210 is connected to the sensor controller 232 of the sensor module 230 via a sensor bus 212 and the microcontroller 224, and instructions and data are transmitted there between through an intermediary agency, i.e., the microcontroller 224. The sensor bus 212 is I²C/SPI bus in general, but is not limited thereto.

In the first embodiment of the present invention, the non-volatile memory 226 stores the saved data or the hardware execution data relative to the memory storage module 220 and the sensor module 230. When the primary processor 210 accesses the saved data or the hardware execution data relative to the memory storage module 220, the primary processor 210 transmits a read instruction or a write instruction to the eMMC controller 222 of the memory storage module 220 via the MMC bus 211, and the eMMC controller 222 reads, according to the read instruction, the saved data or the hardware execution data relative to the memory storage module 220 from the non-volatile memory 226 via the microcontroller 224 or writes, according to the write instruction, it to the non-volatile memory 226. When the primary processor 210 accesses the saved data or the hardware execution data relative to the sensor module 230, the primary processor 210 transmits a read instruction or a write instruction to the sensor controller 232 of the sensor module 230 via the sensor bus 212 and the microcontroller 224, and the sensor controller 232 reads, according to the read instruction, the saved data or the hardware execution data relative to the sensor module 230 from the non-volatile memory 226 via a transmission interface between sensor controller 232 and the memory storage module 220 by use of the shared microcontroller 224 or writes, according to the write instruction, it to the non-volatile memory 226. The microcontroller 224 is shared and utilized by the eMMC controller 222 of the memory storage module 220 and the sensor controller 232 of the sensor module 230. Meanwhile, function algorithms or other relative computations required by the memory storage module 220 and the sensor module 230 are all executed in the shared microcontroller 224. The non-volatile memory 226 stores the saved data or the hardware execution data relative to the memory storage module 220 and the sensor module 230 at the same time.

In the first embodiment of the present invention, the eMMC controller 222 and the microcontroller 224 of the memory storage module 220 are packaged in a same package body, as shown in FIG. 2. MCP (Multi Chip Package) and stacking technology may be adopted to package the eMMC controller 222 and the non-volatile memory 226 together to form the memory storage module 220. In such an approach, the non-volatile memory 226 is stacked with the eMMC controller 222 and the microcontroller 224. Depending on demands, the stacking allows the memory capacity to be adjusted by increasing or decreasing the number of stacked layers. It is convenient for memory capacity design in such way. The sensor controller 232 of the sensor module 230 is packaged in another package body, which is different from the package body of the memory storage module 220. The sensor controller 232 of the sensor module 230 can use and operate the microcontroller 224 and the non-volatile memory 226 in the package body of the memory storage module 220 through the transmission interface between the sensor controller 232 and the memory storage module 220.

In the first embodiment of the present invention, the memory storage module 220 and the sensor module 230 share the microcontroller 224 and the non-volatile memory 226. Both of the eMMC controller 222 of the memory storage module 220 and the sensor controller 232 of the sensor module 230 share a same microcontroller 224 and operate it to access the data stored in the non-volatile memory 226. The saved data and the hardware execution data relative to both of the eMMC controller 222 and the sensor controller 232 are stored in the non-volatile memory 226. Meanwhile, function algorithms or other relative computations required by the memory storage module 220 or the sensor module 230 are all executed in the shared microcontroller 224. Compared to the conventional electronic devices, the microcontroller 222 and the non-volatile memory 226 of the present embodiment are shared by the memory storage module 220 and the sensor module 230, and therefore it does not need to deploy a separated microcontroller and a separated non-volatile memory for each of the memory storage module and the sensor module as the conventional skills do. Therefore, compared to the conventional skills, the present embodiment reduce the use of silicon intellectual property, the cost of silicon wafer is accordingly reduced, and the cost of packaging is lowered as well.

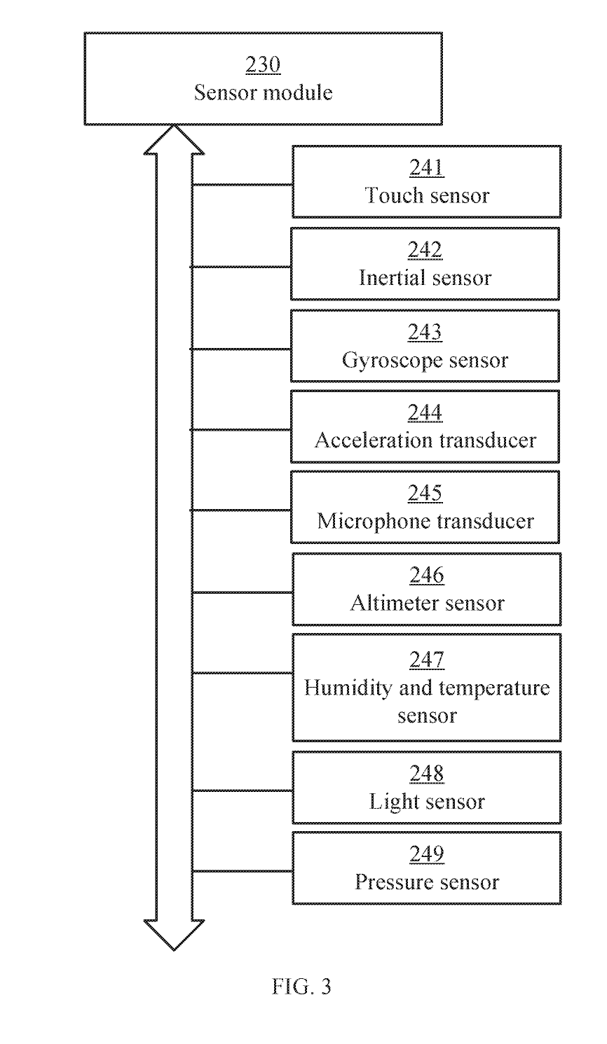

In different embodiments, referring to FIG. 3, the sensor controller 232 can be used to control one or more sensors. The aforesaid sensors may include a touch sensor 241, an inertial sensor 242, a gyroscope sensor 243, an acceleration transducer 244, a microphone transducer 245, an altimeter sensor 246, a humidity and temperature sensor 247, a light sensor 248, and a pressure sensor 249. It should be noted that the above listed sensors 241-249 are merely for illustration, but the present invention is not limited thereto. In addition, when the sensor module 230 is used to control more than one sensor, the sensor module 230 can be served as a sensor hub.

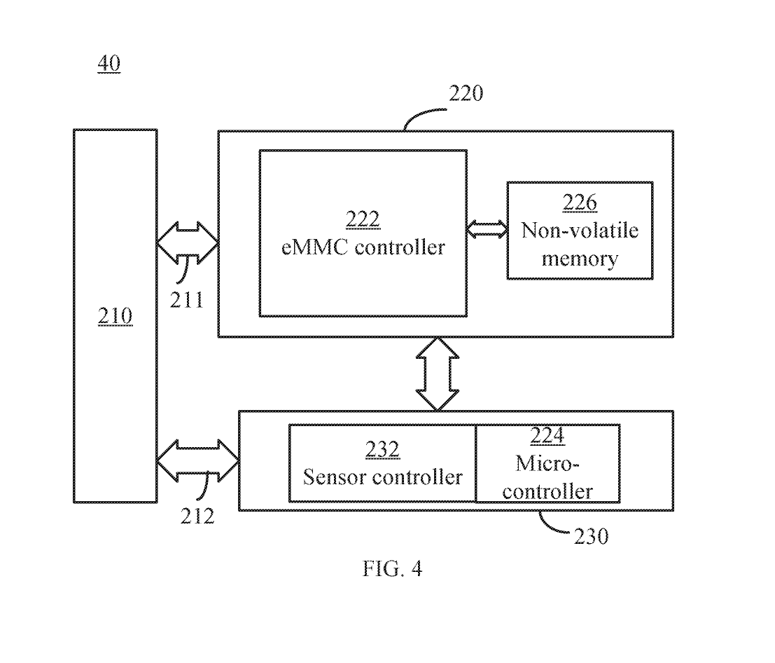

The microcontroller 224 of the present invention can also be disposed in the sensor module 230 in addition to be disposed in the memory storage module 220 as shown in the first embodiment. Please refer to FIG. 4, which is a block diagram showing a device 40 in accordance with a second embodiment of the present invention. The device 40 of the second embodiment of the present invention is similar to the device 20 of the first embodiment of the present invention, and the differences therebetween are that in the second embodiment, the microcontroller 224 is disposed in the sensor module 230, and the microcontroller 224 is packaged in a packaging structure as the same as that of the sensor controller 232 of the sensor module 230. Also, the sensor module 230 is coupled to the memory storage module 220 via a transmission interface such that data can be transmitted between the sensor module 230 and the memory storage module 220. Specifically, in the device 40, the eMMC controller 222 of the memory storage module 220 accesses the non-volatile memory 226 via the transmission interface between the eMMC controller 222 and the sensor module 230 by use of the resource of the microcontroller 224 packaged in the sensor controller 230; the sensor controller 232 of the sensor module 230 may access the non-volatile memory 226 via the aforesaid transmission interface by directly using the microcontroller 224 packaged therewith.

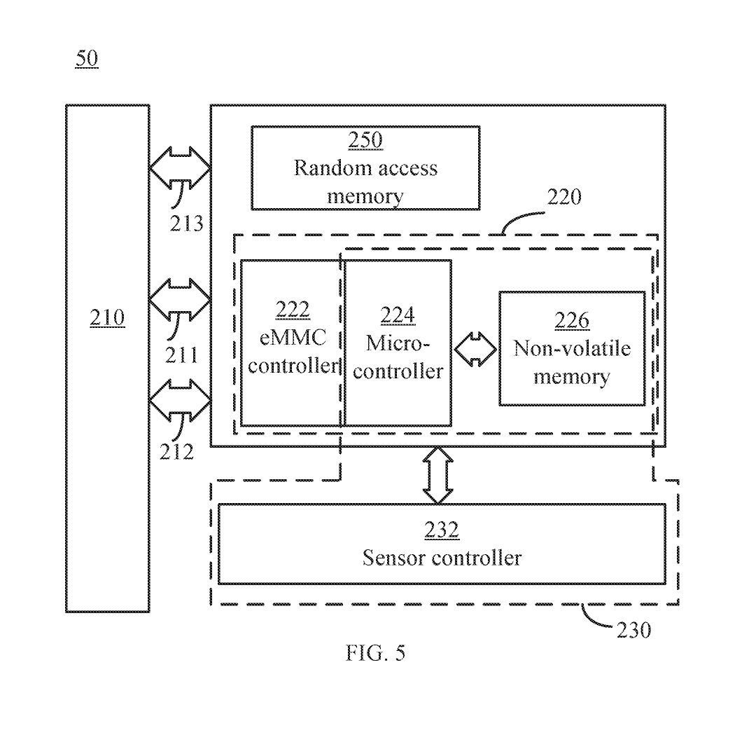

FIG. 5 is a block diagram showing a device 50 in accordance with a third embodiment of the present invention. The device 50 of the third embodiment of the present invention is similar to the device 20 of the first embodiment of the present invention, and the difference therebetween is that the device 50 of the third embodiment further comprises a random access memory (RAM) 250, which is a memory storage specifically for hand-held electronic devices. The random access memory 50 can be Low-Power Double Data Rate (LPDDR) dynamic random-access memory for example, but is not limited thereto. The random access memory 250 is dedicated to the primary processor 210. As shown in FIG. 5, the random access memory 250 and the memory storage module 220 are packaged in a same packaging structure, forming an embedded multi-chip package such as eMCP. That is, the present invention is also applicable to the memory storage module in the eMCP architecture. In the packaging structure, the primary processor 210 is connected to the random access memory 250 via a LPDDR bus 213. The package for any packaging structure of the present invention can be carried out by various technologies such as Wire Bonding, Flip-chip, and Package on Package (POP).

As shown in FIG. 5, the packaging structure of the memory storage module 220 and the random access memory 250 comprise a sensor bus 212. The sensor bus 212 is connected between the primary processor 210 and the packaging structure of the memory storage module 220 and the random access memory 250. The sensor controller 230 is connected to said packaging structure via another transmission interface. Therefore, the primary processor 210 can communicate with the sensor controller 232 via the sensor bus 212 and said another transmission interface between the sensor controller 232 and the packaging structure of the memory storage module 220 and the random access memory 250.

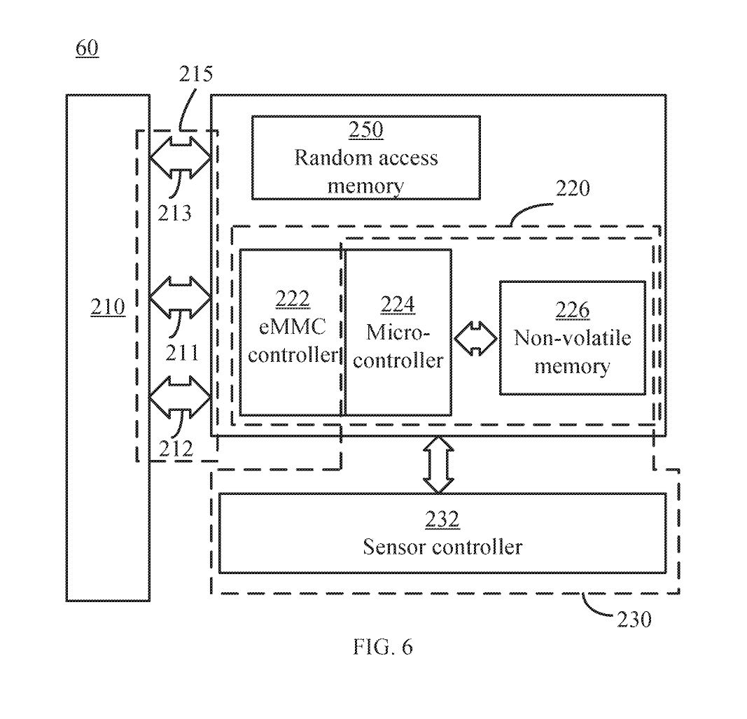

FIG. 6 is a block diagram showing a device 60 in accordance with the fourth embodiment of the present invention. The structure of the device 60 is similar to the third embodiment of the present invention, and the difference therebetween is that as shown in FIG. 6, the MMC bus 211, the sensor bus 212, and the LPDDR bus 213 construct a transmission bus 215 connected between the primary processor 210 and the packaging structure of the memory storage module 220 and the random access memory 250. Compared to the conventional skills, such a transmission bus 215 has high compatibility, and also comprises the pins corresponding to the sensor controller 232 of the sensor module 230 in addition to the pins 211 of the MMC bus 211.

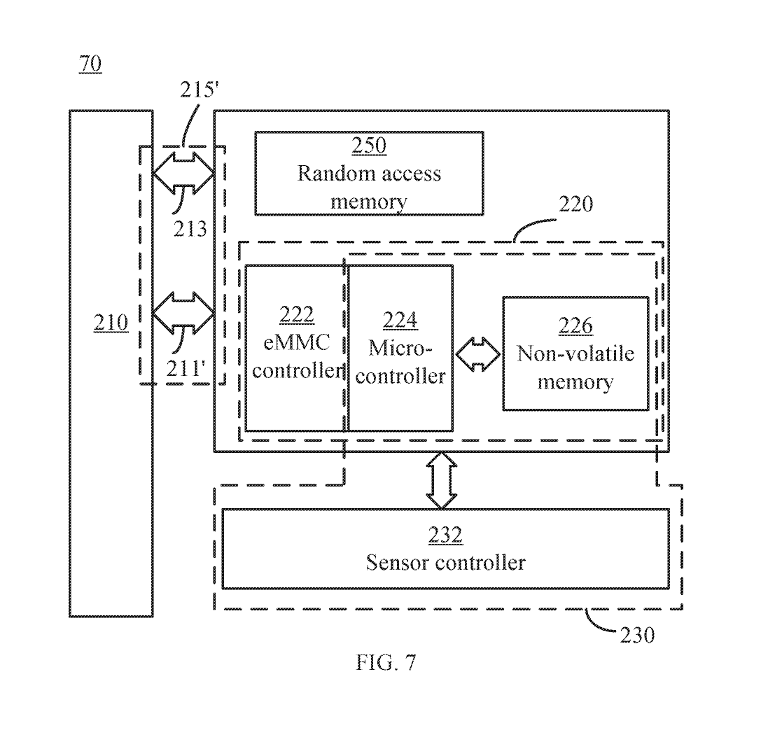

FIG. 7 is a block diagram showing a device 70 in accordance with the fifth embodiment of the present invention. The structure of the device 70 is similar to the fourth embodiment of the present invention, and the difference therebetween is that in the fifth embodiment, the bus 211′ is a new serial interface port or a new type interface which can replace the original interface. The bus 211′ may be adjusted based on the original framework of the MMC bus such that the pins of the bus 211′ can be provided for signal transmission of the eMMC controller 222 and the sensor controller 232. The new serial interface port 211′ of the fifth embodiment of the present invention is different from conventional skills.

In one embodiment, the primary processor 210 may directly transmit instructions to the microcontroller 224 via the transmission bus 215 or 215′. The microcontroller 224 transfers the instructions to the eMMC controller 222 and the instructions being processed thereby if the instructions are instructions relative to the memory storage module 220. The microcontroller 224 transfers the instructions to the sensor controller 232 via the transmission interface between the sensor module 230 and the packaging structure of the memory storage module 220 and the random access memory 250, and the instructions being processed thereby if the instructions are instructions relative to the sensor controller 230.

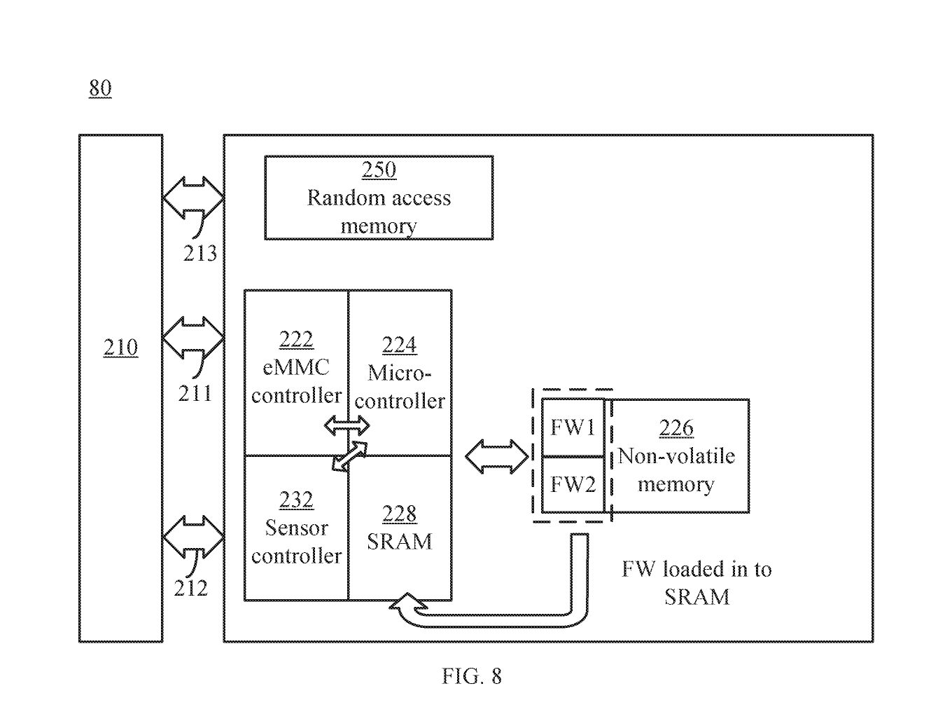

FIG. 8 is a block diagram showing a device 80 in accordance with the sixth embodiment of the present invention. As shown in the device 80 of FIG. 8, the eMMC controller 222 and the sensor controller 232 share a microcontroller 224. Meanwhile, the eMMC controller 222 and the sensor controller 232 also share a static random access memory (SRAM) 228. In the use of the static random access memory 228, the data in the non-volatile memory 226 may be read first to the static random access memory 228 and the microcontroller 224 may then access the static random access memory 228. In this way, data access performance is improved. In addition, software drivers or function firmware FW1 of the eMMC controller 222 and software drivers or function firmware FW2 of the sensor controller 232 are separately deployed or integratedly stored in the non-volatile memory 226. When the system is starting or initializing or when required, the function firmware FW1, FW2, or the integrated function firmware of the eMMC controller 222 and the sensor controller 232, deployed in the non-volatile memory 226, may be loaded into the static random access memory 228. When the system is running, it can also read a part of software codes in the firmware FW1, FW2 for executing the required function corresponding to said part of software codes.

Moreover, the eMMC controller 222, the sensor controller 232, the microcontroller 224, and the static random access memory 228 may be integrated in the one design or said one chip and manufactured on the one piece of wafer, as shown in FIG. 8. After that, MCP (Multi Chip Package) and packaging technology may be adopted to package a one chip with the non-volatile memory 226 and/or the random access memory 250, that is, they are packaged in a same packaging structure. Compared to the individual packaging of the eMMC controller and the sensor controller in the conventional skills, the sixth embodiment of the present invention integrates the memory storage module and the sensor module in such a packaging can efficiently reduce the cost of packaging as well as the number of modules.

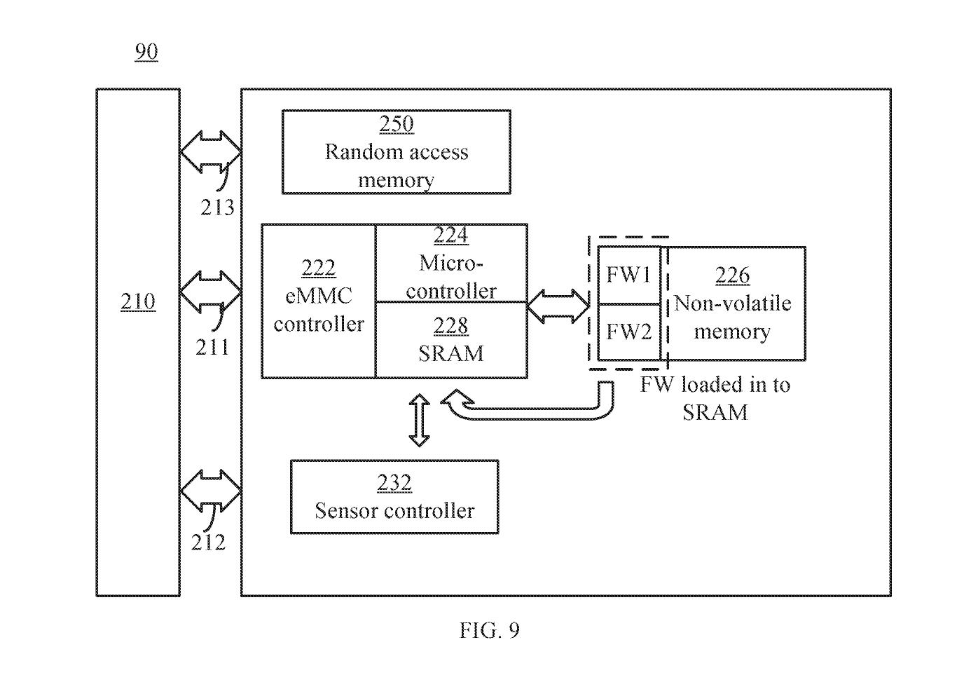

FIG. 9 is a block diagram showing a device 90 in accordance with the seventh embodiment of the present invention. The structure of the device 90 is similar to the sixth embodiment of the present invention, and the difference therebetween is that in the seventh embodiment of the present invention, the eMMC controller 222 and the sensor controller 232 are designed in two chips and manufactured on different wafers, however, the eMMC controller 222, the sensor controller 232, the microcontroller 224, the volatile memory 228, and the non-volatile memory 226 (and the random access memory 250) are still packaged in one packaging structure.

It should be noted that in other embodiments, the device may have a structure similar to any one of the third embodiment to the seventh embodiment of the present invention but the microcontroller 224 is deployed in the sensor module 230. Integration of the microcontroller and the non-volatile memory in the above embodiments is similar to that in the first embodiment to the seventh embodiment of the present invention, and thus are not detailed herein.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. An integrated framework of a memory storage module and a sensor module, comprising:
an embedded memory storage device controller;
a microcontroller coupled to the embedded memory storage device controller;
a non-volatile memory coupled to the microcontroller, the embedded memory storage device controller reading a data from the non-volatile memory or writing the data to the non-volatile memory by use of the microcontroller; and
a sensor controller for controlling a sensing element to generate or receive a sensing signal;
wherein the sensor controller is coupled to the microcontroller, and the sensor controller reads the data from the non-volatile memory or writing the data to the non-volatile memory by use of the microcontroller.

2. The integrated framework according to claim 1, wherein the embedded memory storage device controller and the sensor controller share the microcontroller and the non-volatile memory.

3. The integrated framework according to claim 1, wherein the embedded memory storage device controller, the microcontroller, and the non-volatile memory are packaged in a same packaging structure, or the embedded memory storage device controller, the sensor controller, the microcontroller, and the non-volatile memory are packaged in a same packaging structure.

4. The integrated framework according to claim 3, wherein the non-volatile memory is packaged, by a way of stacking, with the embedded memory storage device controller and the sensor controller in a same packaging structure.

5. The integrated framework according to claim 1, wherein the sensor controller and the microcontroller are packaged in a same packaging structure.

6. The integrated framework according to claim 1, wherein the embedded memory storage device controller and the sensor controller are connected to a primary processor respectively via a first bus and a second bus, and wherein the first bus and the second bus are buses of different architectures.

7. The integrated framework according to claim 1, wherein signal transmission between the sensor controller and a primary processor is carried out by a first transmission interface between the sensor controller and a packaging structure of the embedded memory storage device controller and a second transmission interface between the primary processor and the packaging structure of the embedded memory storage device controller.

8. The integrated framework according to claim 7, wherein the second transmission interface comprises a sensor bus having pins for transmitting signals, and the type thereof corresponds to input or output ports of the sensor controller.

9. The integrated framework according to claim 7, wherein the sensor controller and the embedded memory storage device controller transmit, via a same bus, signals to or from the primary processor.

10. The integrated framework according to claim 1, further comprising:
a primary processor coupled to the microcontroller via a bus, the primary processor directly transmitting instructions to the microcontroller; the microcontroller transferring the instructions to the embedded memory storage device controller and the instructions being processed thereby if the instructions are instructions relative to the embedded memory storage device controller; the microcontroller transferring the instructions to the sensor controller and the instructions being processed thereby if the instructions are instructions relative to the sensor controller.

11. The integrated framework according to claim 1, wherein saved data or hardware execution data of the embedded memory storage device controller and the sensor controller are deployed in the non-volatile memory.

12. The integrated framework according to claim 1, wherein the sensor controller is coupled to at least one sensor, which comprises at least one of touch sensor, inertial sensor, gyroscope, acceleration transducer, and microphone transducer.
